(19) United States
(12) Patent Application Publication
(10) Pub. No.: US 2025/0182316 A1
(43) Pub. Date: Jun. 5, 2025

(54) INFORMATION PROCESSING DEVICE AND INFORMATION PROCESSING METHOD

(71) Applicant: Sony Semiconductor Solutions Corporation, Atsugi-shi, Kanagawa (JP)

(72) Inventor: Serge HUSTIN, Stuttgart (DE)

(73) Assignee: Sony Semiconductor Solutions Corporation, Atsugi-shi, Kanagawa (JP)

(21) Appl. No.: 18/842,051

(22) PCT Filed: Feb. 27, 2023
(86) PCT No.: PCT/EP2023/054874

§ 371 Date: Aug. 28, 2024

(30) Foreign Application Priority Data
Mar. 7, 2022 (EP) 22160430.9

(51) Int. Cl. G06T 7/70; G01S 17/86; G06T 7/20; G06T 7/579

(52) U.S. Cl. CPC G06T 7/70; G01S 17/86; G06T 7/20; G06T 7/579

(57) ABSTRACT

An information processing device for simultaneous localization and mapping, including circuitry configured to: obtain time-of-flight data of an environment of the information processing device; detect, based on the time-of-flight data, a floor in the environment; obtain image data representing an image of the environment; track, based on the image data, the floor; and localize the information processing device in the environment, based on the detected and tracked floor.

### TECHNICAL FIELD

The present disclosure generally pertains to an information processing device and a corresponding information processing method for simultaneous localization and mapping.

### TECHNICAL BACKGROUND

Generally, various methods for simultaneous localization and mapping (“SLAM”) are known. Applications like 3D room scanning, for example performed with a smartphone, typically rely on data from accelerometers and a camera to track the position of the camera as it scans the rooms. However, this approach may have limitations as the tracking may be lost, e.g., when the camera is in front of a scene with not enough visible features—e.g., a wall with a uniform colour—which prevents the camera from compensating the drift of the accelerometers.

A typical solution is to detect that the tracking has been lost, to notify the user and have him return to a place with enough visible known features for the tracking to restart.

However, such back-tracking may be cumbersome and unreliable, in some cases, and may not solve the problem that caused the tracking loss which still need to be worked around.

Although there exist techniques for simultaneous localization and tracking, it is generally desirable to improve the existing techniques.

### SUMMARY

According to a first aspect the disclosure provides an information processing device for simultaneous localization and mapping, comprising circuitry configured to:
obtain time-of-flight data of an environment of the information processing device;
detect, based on the time-of-flight data, a floor in the environment;
obtain image data representing an image of the environment;
track, based on the image data, the floor; and
localize the information processing device in the environment, based on the detected and tracked floor.

According to a second aspect the disclosure provides an information processing method for simultaneous localization and mapping, comprising:
obtaining time-of-flight data of an environment of an information processing device;
detecting, based on the time-of-flight data, a floor in the environment;
obtaining image data representing an image of the environment;
tracking, based on the image data, the floor; and
localizing the information processing device in the environment, based on the detected and tracked floor.

Further aspects are set forth in the dependent claims, the following description and the drawings.

### BRIEF DESCRIPTION OF THE DRAWINGS

Embodiments are explained by way of example with respect to the accompanying drawings, in which:

FIG. 1 schematically illustrates in a block diagram four embodiments of an information processing device;

FIG. 2 schematically illustrates in a block diagram an embodiment of an information processing device;

FIG. 3 schematically illustrates in a flow diagram an embodiment of an information processing method; and

FIG. 4 schematically illustrates in a flow diagram an embodiment of an information processing method.

### DETAILED DESCRIPTION OF EMBODIMENTS

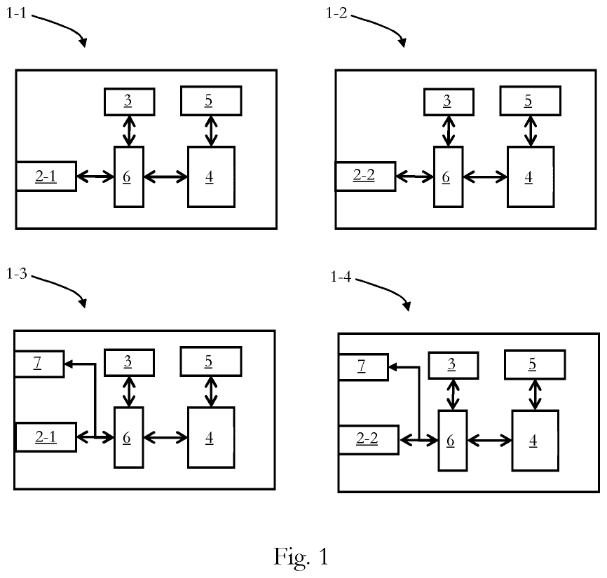

Before a detailed description of the embodiments under reference of FIG. 1 is given, general explanations are made.

As mentioned in the outset, generally, various methods for simultaneous localization and mapping (“SLAM”) are known. Applications like 3D room scanning, for example performed with a smartphone, typically rely on data from accelerometers and a camera to track the position of the camera as it scans the rooms. However, this approach may have limitations as the tracking may be lost, e.g., when the camera is in front of a scene with not enough visible features—e.g., a wall with a uniform colour—which prevents the camera from compensating the drift of the accelerometers.

A typical solution is to detect that the tracking has been lost, to notify the user and have him return to a place with enough visible known features for the tracking to restart.

However, such back-tracking may be cumbersome and unreliable, in some cases, and may not solve the problem that caused the tracking loss which still need to be worked around.

Hence, it has been recognized that the number of situations in which the camera loses track should be reduced while improving the position accuracy.

It has been recognized that at least one downward facing camera and optionally additional sensors (e.g., an inertial measurement unit (“IMU”)) may be used and that their inputs into the position tracking SLAM algorithm may be merged, in some embodiments, as follows:
A downward facing depth sensing device (referred herein also as time-of-flight device) is used, in some embodiments, to provide a direct, robust measurement of the height of the camera.
A downward facing depth sensing device is used, in some embodiments, to compute a robust, acceleration independent of the vertical direction, by identifying and measuring the position of the horizontal parts of the floor.
A downward facing camera is used, in some embodiments, to capture the horizontal movement by feeding the images of the floor into the SLAM algorithm.

Hence, some embodiments pertain to an information processing device for simultaneous localization and mapping, wherein the information processing device includes circuitry configured to:
obtain time-of-flight data of an environment of the information processing device;
detect, based on the time-of-flight data, a floor in the environment;
obtain image data representing an image of the environment;
track, based on the image data, the floor; and
localize the information processing device in the environment, based on the detected and tracked floor.

The information processing device may be a smartphone, a tablet, an image or video capturing device, or the like.

The information processing device may be used, for example, for room scanning applications (e.g., scanning an interior of a building) or may be installed in a drone to scan a terrain or street arrangements or the like.

The circuitry may be based on or may include or may be implemented by typical electronic components configured to achieve the functionality as described herein.

The circuitry may be based on or may include or may be implemented as integrated circuitry logic and the functionality may be implemented by software executed by a processor or the like.

The circuitry may be based on or may include or may be implemented by a CPU (central processing unit), a microcontroller, an FPGA (field programmable gate array), an ASIC (application specific integrated circuit), a GPU (graphical processing unit), a DSP (digital signal processor) or the like.

The circuitry may be based on or may include or may be implemented in parts by typical electronic components and integrated circuitry logic and in parts by software.

The circuitry may include storage capabilities such as magnetic storage, semiconductor storage, etc.

The circuitry may include a data bus for transmitting and receiving data and may implement corresponding communication protocols.

The time-of-flight (“ToF”) data may be direct time-of-flight data or indirect time-of-flight data.

Direct time-of-flight data may be obtained from a direct time-of-flight device (which is also known as a LiDAR (“Light Detection And Ranging”) device), which includes, in some embodiments, as generally known, a light source configured to emit light pulses, an image sensor having a plurality of time-of-flight pixels (e.g., SPAD (“Single Photon Avalanche Diode”) pixels) configured to detect light and to generate an electric signal in response to the detected light, and a control unit configured to control the overall operation of the direct time-of-flight device and to generate, based on the generated electric signals of the time-of-flight pixels, histogram data indicating a number of electric signals (which may also be referred to as events) generated in a certain time interval since emission of the light pulse (“time of arrival”), thereby indicating a distance to an object which reflects at least a part of the emitted light pulse.

Indirect time-of-flight data may be obtained from an indirect time-of-flight device, which includes, in some embodiments, as generally known, a light source configured to emit light modulated in time in accordance with a modulation signal with a modulation frequency, an image sensor having a plurality of time-of-flight pixels (e.g., CAPD (“Current Assisted Photonic Demodulator”) pixels) configured to detect light and to generate an electric signal in response to the detected light in accordance with a demodulation signal applied to the respective time-of-flight pixel, and a control unit configured to control the overall operation of the indirect time-of-flight device and to perform at least two correlation measurements—typically four (phase shifts of 0°, 90°, 180° and 270° between the modulation signal and the demodulation signal)—and to generate phase data (representing a phase image) and amplitude data (representing an amplitude image) based on the electric signals of the time-of-flight pixels generated within the at least two correlation measurements.

The direct or indirect time-of-flight device may include a light source which is or includes a full-field illuminator or a spot illuminator.

The full-field illuminator, in some embodiments, provides a full-field illumination to the environment such that the environment is illuminated with a continuous spatial light profile. For example, a light beam which has a high-intensity area in the center of the light beam with a continuously decreasing light intensity away from the center of the light beam.

The spot illuminator, in some embodiments, provides a spotted illumination to the environment such that the environment is illuminated with a plurality of light spots. In other words, the environment is illuminated with a light pattern of (separated) high-intensity and low-intensity (or substantially zero-intensity) areas such as, for example, a pattern of light spots (e.g., light dots). In some embodiments, the spot illuminator provides a spatially modulated light field-of-illumination (light pattern) with vertical or horizontal stripes or with a checker pattern. Generally, in some embodiments, the spot illuminator provides a spatially modulated field-of-illumination (light pattern) to the environment where a light intensity is low (or substantially zero) in part of the light pattern.

In some embodiments, the information processing device includes a time-of-flight device configured to acquire the time-of-flight data and the image data.

In some embodiments, the time-of-flight data are indirect time-of-flight data. In such embodiments, the image data correspond to amplitude data obtained based on the indirect time-of-flight data.

Hence, depth information and image information of the environment is obtained with a single device.

Moreover, in some embodiments, the light source of the indirect time-of-flight device (which is used to acquire the indirect time-of-flight data) is or includes a full-field illuminator.

In some embodiments, the light source of the indirect time-of-flight device (which is used to acquire the indirect time-of-flight data) is or includes a spot illuminator. In such embodiments, the indirect time-of-flight device is operating in a common mode which relies on ambient light.

In some embodiments, the time-of-flight device includes an image sensor including a plurality of time-of-flight pixels for acquiring the time-of-flight data and a plurality of image pixels for acquiring the image data. Hence, depth information and image information of the environment is obtained with a single device, wherein depth information is acquired with the time-of-flight pixels and image information is acquired with the image pixels.

For example, a half of the image sensor includes the time-of-flight pixels, and the other half of the image sensor includes the image pixels, which may also be present mixed on the image sensor.

In some embodiments, the information processing device includes a time-of-flight device configured to acquire the time-of-flight data and a camera configured to acquire the image data. Hence, depth information and image information of the environment is obtained with two different devices.

For example, when the time-of-flight device is a direct time-of-flight device (LiDAR) used to acquire the time-of-flight data, a camera is used to acquire the image data.

In some embodiments, the information processing device further includes a camera configured to acquire second image data representing a second image of the environment, wherein the circuitry is configured to track the floor further based on the second image data and to localize the information processing device further based on the second image data. In such embodiments, the information processing device includes the time-of-flight device configured to acquire the time-of-flight data and the image data and a second device, the camera, to acquire second image data for improving stability and precision of the tracking and localization.

In some embodiments, the circuitry is configured to obtain, based on the time-of-flight data, a height of the information processing device and a vertical direction in the environment relative to the detected floor.

In some embodiments, the circuitry is configured to track the floor based on the height and the vertical direction.

In some embodiments, the circuitry is configured to obtain, based on the tracking of the floor, a horizontal position and a horizontal orientation of the information processing device.

In some embodiments, the circuitry is configured to localize the information processing device based on the height, the vertical direction, the horizontal position and the horizontal orientation.

In some embodiments, the circuitry is configured to obtain sensor data, and to detect and track the floor further based on the sensor data.

In some embodiments, the information processing device includes an inertial measurement unit configured to acquire the sensor data.

In some embodiments, the circuitry is configured to localize the information processing device further based on the sensor data.

Some embodiments pertain to a(n) (corresponding) information processing method for simultaneous localization and mapping, wherein the information processing method includes:
obtaining time-of-flight data of an environment of an information processing device;
detecting, based on the time-of-flight data, a floor in the environment;
obtaining image data representing an image of the environment;
tracking, based on the image data, the floor; and
localizing the information processing device in the environment, based on the detected and tracked floor.

The information processing method may be performed by the information processing device as described herein.

The methods as described herein are also implemented in some embodiments as a computer program causing a computer and/or a processor to perform the method, when being carried out on the computer and/or processor. In some embodiments, also a non-transitory computer-readable recording medium is provided that stores therein a computer program product, which, when executed by a processor, such as the processor described above, causes the methods described herein to be performed.

Returning to FIG. 1, there are schematically illustrated in a block diagram four embodiments of an information processing device 1-1, 1-2, 1-3 and 1-4, which are discussed in the following.

The information processing devices 1-1, 1-2, 1-3 and 1-4 may be a smartphone, tablet or the like.

The information processing device 1-1 includes a time-of-flight device 2-1, wherein the time-of-flight device is an indirect time-of-flight device.

The information processing device 1-1 further includes an inertial measurement unit 3 (“IMU”), a processor 4 (e.g., an application processor), a data storage 5 and a data bus 6 (e.g., a data bus in accordance with MIPI (“Mobile Industry Processor Interface Alliance”) specifications).

The processor 4 may load a computer program (“application”) for simultaneous localization and mapping, e.g. for room scanning, from the data storage 5 and may temporarily store data in the data storage 5 during execution of the application.

When the application is started, the time-of-flight device 2-1 acquires indirect time-of-flight data and outputs depth data representing depth information of an environment of the information processing device 1-1 and amplitude data (as image data) representing an amplitude image (as an image) of the environment of the information processing device 1-1 via the data bus 6 to the processor 4.

The IMU 3 acquires sensor data (acceleration and rotation of the information processing device 1-1) and outputs the sensor data via the data bus 6 to the processor 4.

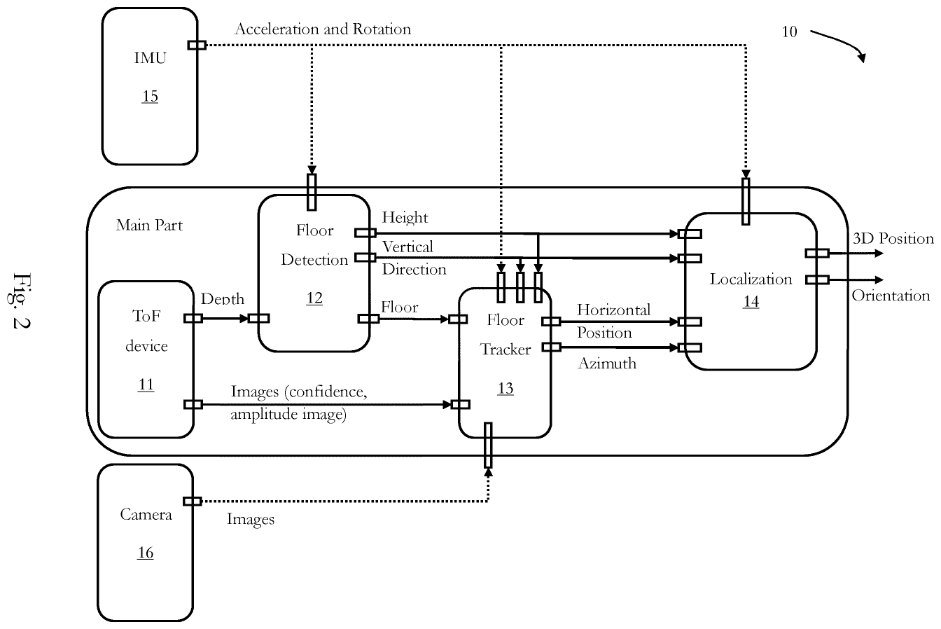

The processor 4 performs room scanning based on the obtained depth data, amplitude data and sensor data, as will be discussed in more detail under reference of FIG. 2.

The information processing device 1-2 includes a time-of-flight device 2-2, wherein the time-of-flight device includes an image sensor including a plurality of time-of-flight pixels for acquiring time-of-flight data and a plurality of image pixels for acquiring image data.

The information processing device 1-2 further includes the IMU 3, the processor 4, the data storage 5 and the data bus 6.

As mentioned above, the processor 4 may load a computer program (“application”) for simultaneous localization and mapping, e.g. for room scanning, from the data storage 5 and may temporarily store data in the data storage 5 during execution of the application.

When the application is started, the time-of-flight device 2-2 acquires time-of-flight data and image data and outputs depth data representing depth information of an environment of the information processing device 1-2 and the image data representing an image of the environment of the information processing device 1-2 via the data bus 6 to the processor 4.

The IMU 3 acquires sensor data (acceleration and rotation of the information processing device 1-2) and outputs the sensor data via the data bus 6 to the processor 4.

The processor 4 performs room scanning based on the obtained depth data, image data and sensor data, as will be discussed in more detail under reference of FIG. 2.

The information processing device 1-3 includes the time-of-flight device 2-1.

The information processing device 1-3 further includes the IMU 3, the processor 4, the data storage 5, the data bus 6 and a camera (e.g., a conventional camera such as a grey scale camera or RGB (“red-green-blue”) camera for acquiring a two-dimensional image).

As mentioned above, the processor 4 may load a computer program (“application”) for simultaneous localization and mapping, e.g. for room scanning, from the data storage 5 and may temporarily store data in the data storage 5 during execution of the application.

When the application is started, the time-of-flight device 2-1 acquires indirect time-of-flight data and outputs depth data representing depth information of an environment of the information processing device 1-3 and amplitude data (as image data) representing an amplitude image (as an image) of the environment of the information processing device 1-3 via the data bus 6 to the processor 4.

The IMU 3 acquires sensor data (acceleration and rotation of the information processing device 1-3) and outputs the sensor data via the data bus 6 to the processor 4.

The camera 7 acquires second image data representing a second image of the environment of the information processing device 1-3 and outputs the second image data via the data bus 6 to the processor 4.

The processor 4 performs room scanning based on the obtained depth data, amplitude data, sensor data and second image data, as will be discussed in more detail under reference of FIG. 2.

The information processing device 1-4 includes the time-of-flight device 2-2.

The information processing device 1-4 further includes the IMU 3, the processor 4, the data storage 5, the data bus 6 and the camera 7.

As mentioned above, the processor 4 may load a computer program (“application”) for simultaneous localization and mapping, e.g. for room scanning, from the data storage 5 and may temporarily store data in the data storage 5 during execution of the application.

When the application is started, the time-of-flight device 2-2 acquires time-of-flight data and image data and outputs depth data representing depth information of an environment of the information processing device 1-4 and the image data representing an image of the environment of the information processing device 1-4 via the data bus 6 to the processor 4.

The IMU 3 acquires sensor data (acceleration and rotation of the information processing device 1-4) and outputs the sensor data via the data bus 6 to the processor 4.

The camera 7 acquires second image data representing a second image of the environment of the information processing device 1-4 and outputs the second image data via the data bus 6 to the processor 4.

The processor 4 performs room scanning based on the obtained depth data, image data and sensor data, as will be discussed in more detail under reference of FIG. 2.

FIG. 2 schematically illustrates in a block diagram an embodiment of an information processing device 10, which is discussed in the following.

The information processing device 10 includes a time-of-flight (“ToF”) device 11, a floor detection module 12, a floor tracker module 13 and a localization module 14.

Optionally, the information processing device 10 further includes an IMU 15 and a camera 16.

The information processing device 10 may correspond to one of the information processing devices 1-1, 1-2, 1-3 and 1-4 of FIG. 1, wherein the IMU 3 of FIG. 1 corresponds to the optional IMU 15 and the camera 7 of FIG. 1 corresponds to the optional camera 16.

The ToF device 11 corresponds to the time-of-flight device 2-1 or 2-2 of FIG. 1.

The floor detection module 12, the floor tracker module 13 and the localization module 14 is implemented by a computer-program for simultaneous localization and mapping executed by the processor 4 of FIG. 1.

The computer-program executed by the processor 4 is a room scanning application.

The ToF device 11 outputs depth data (as time-of-flight data) of the environment of the information processing device 10 to the floor detection module 12, wherein it is assumed that the ToF device 11 faces at least partly downwards.

The floor detection module 12 detects, based on the depth data, a floor in the environment of the information processing device 10. The floor is assumed to be a plane surface in the horizontal directions.

The floor detection module 12 determines in the three-dimensional (“3D”) point cloud—represented by the depth data obtained from the ToF device 11—, e.g., (larger) blocks of coplanar points, for example, in the center of the 3D point cloud for detecting the floor (of the room/environment).

The floor detection module 12 may further detect the floor by determining whether a foot of the user is in the field-of-view of the ToF device 11 which is a feature indicative for a floor area on which the floor detection module 12 can lock on.

The floor detection module 12 may further detect the floor by determining whether an edge or right angle between areas of 3D points of the 3D point cloud is present which may be indicative for a vertical wall on the floor.

The floor detection module 12 computes the set of 3D points in the 3D point cloud which are part of the floor and generates and outputs them as the detected floor to the floor tracker module 13.

Moreover, the floor detection module 12 computes (determines), based on the depth data, a height of the information processing device 10 and a vertical direction (the normal to the floor) in the environment relative to the detected floor. Additionally, the floor detection module 12 determines a vertical orientation of the information processing device 10 relative to the detected floor.

The floor detection module 12 outputs the height and the vertical direction to the floor tracker module 13 and the localization module 14.

The ToF device 11 outputs amplitude data (as image data) representing an amplitude image (as an image) of the environment to the floor tracker module 13.

The floor tracker module 13 tracks, based on the detected floor, the amplitude data (as the image data), the height and the vertical direction, the floor.

Specifically, the floor tracker module 13 compares successive images from the ToF device 11 utilizing the knowledge of the detected floor, the height and the vertical direction by projecting the amplitude data in the floor plane and computes a change in horizontal position and horizontal orientation (azimuth) of the information processing device 10.

Thereby, the floor is tracked and the floor tracker module 13 determines (or updates) a horizontal position and horizontal orientation of the information processing device 10.

The floor tracker module 13 outputs the horizontal position and the horizontal orientation to the localization module 14.

Generally, the localization module 14 stores the vertical direction, all previous heights, horizontal positions and horizontal orientations (and optionally all previous vertical orientations) for localizing the information processing device 10.

The localization module 14 fuses the information about the vertical direction, the height, the horizontal position and the orientations to output the localization (position and orientation) of the information processing device 10.

In other words, the localization module 14 localizes the information processing device 10 in the environment based on the detected and tracked floor by localizing the information processing device 10 based on the height, the vertical direction, the horizontal position and the horizontal orientation, which are determined based on the detected and tracked floor.

The localization module 14 implements a SLAM algorithm, which is generally known to the skilled person and is thus not discussed in further detail.

Optionally, the IMU 15 provides acceleration and rotation data (sensor data) of the information processing device 10 which is used by the floor detection module 12, the floor tracker module 13 and the localization module 14 for improving the precision and for reducing the complexity of the floor detection, floor tracking and localization.

Optionally, the camera 16 provides second image data representing a second image of the environment (e.g., with higher resolution) which is used by the floor tracker module 13 for increasing its precision.

### Summarizing the Embodiment

The ToF device 11 can provide at the same time the height measurement, the vertical direction and the feature tracking from which the SLAM algorithm can track the position of the information processing device 10.

For example, at least one foot of the user may be in the field-of-view of the ToF device 11, providing a minimum set of features to lock on.

Having a direct measurement of the height and the vertical direction allows to avoid accelerometer (e.g., the IMU 15) errors induced drift in the vertical direction, and to distinguish the acceleration from the earth attraction.

The downward facing ToF device 10 has predictable conditions, e.g., with a range limited to the height of the person who carries the camera.

The downward facing ToF device 10 can provide direct measurements for SLAM algorithm key components which are otherwise measured indirectly, and, in some cases, as generally known, unreliably.

A downward facing TOF device 10 may be used in combination with a (SLAM) camera 17 (and thus does not drift even when conventional cameras have no features to lock on (e.g., when it is occluded)).

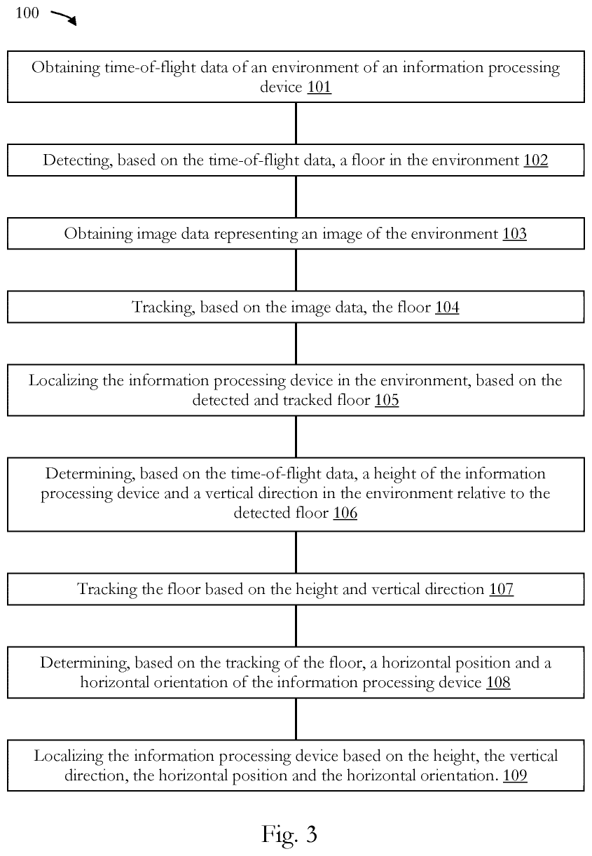

FIG. 3 schematically illustrates in a flow diagram an embodiment of an information processing method 100, which is discussed in the following.

The information processing method 100 may be performed by an information processing device as discussed herein.

At 101, time-of-flight data of an environment of an information processing device is obtained, as discussed herein.

At 102, based on the time-of-flight data, a floor in the environment is detected, as discussed herein.

At 103, image data representing an image of the environment is obtained, as discussed herein.

At 104, based on the image data, the floor is tracked, as discussed herein.

At 105, the information processing device is localized in the environment, based on the detected and tracked floor, as discussed herein.

At 106, based on the time-of-flight data, a height of the information processing device and a vertical direction in the environment relative to the detected floor are determined, as discussed herein.

At 107, the floor is tracked in the image data based on the height and vertical direction, as discussed herein.

At 108, based on the tracking of the floor, a horizontal position and a horizontal orientation of the information processing device is determined, as discussed herein.

At 109, the information processing device is localized based on the height, the vertical direction, the horizontal position and the horizontal orientation, as discussed herein.

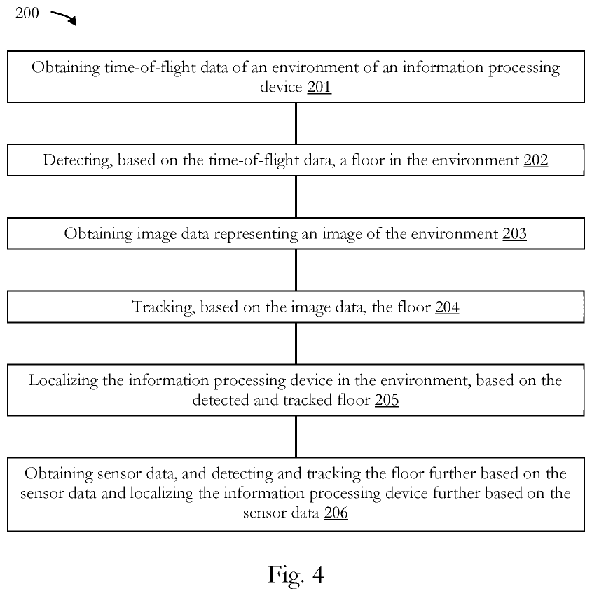

FIG. 4 schematically illustrates in a flow diagram an embodiment of an information processing method 200, which is discussed in the following.

The information processing method 200 may be performed by an information processing device as discussed herein.

At 201, time-of-flight data of an environment of an information processing device is obtained, as discussed herein.

At 202, based on the time-of-flight data, a floor in the environment is detected, as discussed herein.

At 203, image data representing an image of the environment is obtained, as discussed herein.

At 204, based on the image data, the floor is tracked, as discussed herein.

At 205, the information processing device is localized in the environment, based on the detected and tracked floor, as discussed herein.

At 206, sensor data is obtained, and detecting and tracking the floor further based on the sensor data and localizing the information processing device further based on the sensor data, as discussed herein.

It should be recognized that the embodiments describe methods with an exemplary ordering of method steps. The specific ordering of method steps is however given for illustrative purposes only and should not be construed as binding.

All units and entities described in this specification and claimed in the appended claims can, if not stated otherwise, be implemented as integrated circuit logic, for example on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below.
(1) An information processing device for simultaneous localization and mapping, wherein the information processing device includes circuitry configured to:
   obtain time-of-flight data of an environment of the information processing device;
   detect, based on the time-of-flight data, a floor in the environment;
   obtain image data representing an image of the environment;
   track, based on the image data, the floor; and
   localize the information processing device in the environment, based on the detected and tracked floor.
(2) The information processing device of (1), wherein the circuitry is configured to determine, based on the time-of-flight data, a height of the information processing device and a vertical direction in the environment relative to the detected floor.
(3) The information processing device of (2), wherein the circuitry is configured to track the floor based on the height and the vertical direction.
(4) The information processing device of (3), wherein the circuitry is configured to determine, based on the tracking of the floor, a horizontal position and a horizontal orientation of the information processing device.
(5) The information processing device of (4), wherein the circuitry is configured to localize the information processing device based on the height, the vertical direction, the horizontal position and the horizontal orientation.
(6) The information processing device of anyone of (1) to (5), wherein the circuitry is configured to obtain sensor data, and to detect and track the floor further based on the sensor data.
(7) The information processing device of (6), wherein the circuitry is configured to localize the information processing device further based on the sensor data.
(8) The information processing device of anyone of (1) to (7), wherein the information processing device includes a time-of-flight device configured to acquire the time-of-flight data and the image data.
(9) The information processing device of (8), wherein the time-of-flight data are indirect time-of-flight data.
(10) The information processing device of (9), wherein the image data correspond to amplitude data obtained based on the indirect time-of-flight data.
(11) The information processing device of (8) or (9), wherein the time-of-flight device includes an image sensor including a plurality of time-of-flight pixels for acquiring the time-of-flight data and a plurality of image pixels for acquiring the image data.
(12) The information processing device of anyone of (8) to (11), further including a camera configured to acquire second image data representing a second image of the environment, wherein the circuitry is configured to track the floor further based on the second image data and to localize the information processing device further based on the second image data.
(13) The information processing device of anyone of (1) to (7), wherein the information processing device includes a time-of-flight device configured to acquire the time-of-flight data and a camera configured to acquire the image data.
(14) The information processing device of anyone of (6) to (13), wherein the information processing device includes an inertial measurement unit configured to acquire the sensor data.
(15) An information processing method for simultaneous localization and mapping, wherein the information processing method includes:
   obtaining time-of-flight data of an environment of an information processing device;
   detecting, based on the time-of-flight data, a floor in the environment;
   obtaining image data representing an image of the environment;
   tracking, based on the image data, the floor; and
   localizing the information processing device in the environment, based on the detected and tracked floor.
(16) The information processing method of (15), further including: determining, based on the time-of-flight data, a height of the information processing device and a vertical direction in the environment relative to the detected floor.
(17) The information processing method of (16), further including: tracking the floor based on the height and vertical direction.
(18) The information processing method of (17), further including: determining, based on the tracking of the floor, a horizontal position and a horizontal orientation of the information processing device.
(19) The information processing method of (18), further including: localizing the information processing device based on the height, the vertical direction, the horizontal position and the horizontal orientation.
(20) The information processing method of anyone of (15) to (19), further including: obtaining sensor data, and detecting and tracking the floor further based on the sensor data and localizing the information processing device further based on the sensor data.
(21) A computer program comprising program code causing a computer to perform the method according to anyone of (15) to (20), when being carried out on a computer.
(22) A non-transitory computer-readable recording medium that stores therein a computer program product, which, when executed by a processor, causes the method according to anyone of (15) to (20) to be performed.

1. An information processing device for simultaneous localization and mapping, comprising circuitry configured to:
obtain time-of-flight data of an environment of the information processing device;
detect, based on the time-of-flight data, a floor in the environment;
obtain image data representing an image of the environment;
track, based on the image data, the floor; and
localize the information processing device in the environment, based on the detected and tracked floor.

2. The information processing device according to claim 1, wherein the circuitry is configured to determine, based on the time-of-flight data, a height of the information processing device and a vertical direction in the environment relative to the detected floor.

3. The information processing device according to claim 2, wherein the circuitry is configured to track the floor based on the height and the vertical direction.

4. The information processing device according to claim 3, wherein the circuitry is configured to determine, based on the tracking of the floor, a horizontal position and a horizontal orientation of the information processing device.

5. The information processing device according to claim 4, wherein the circuitry is configured to localize the information processing device based on the height, the vertical direction, the horizontal position and the horizontal orientation.

6. The information processing device according to claim 1, wherein the circuitry is configured to obtain sensor data, and to detect and track the floor further based on the sensor data.

7. The information processing device according to claim 6, wherein the circuitry is configured to localize the information processing device further based on the sensor data.

8. The information processing device according to claim 1, comprising a time-of-flight device configured to acquire the time-of-flight data and the image data.

9. The information processing device according to claim 8, wherein the time-of-flight data are indirect time-of-flight data.

10. The information processing device according to claim 9, wherein the image data correspond to amplitude data obtained based on the indirect time-of-flight data.

11. The information processing device according to claim 8, wherein the time-of-flight device includes an image sensor including a plurality of time-of-flight pixels for acquiring the time-of-flight data and a plurality of image pixels for acquiring the image data.

12. The information processing device according to claim 8, further comprising a camera configured to acquire second image data representing a second image of the environment, wherein the circuitry is configured to track the floor further based on the second image data and to localize the information processing device further based on the second image data.

13. The information processing device according to claim 1, comprising a time-of-flight device configured to acquire the time-of-flight data and a camera configured to acquire the image data.

14. The information processing device according to claim 6, comprising an inertial measurement unit configured to acquire the sensor data.

15. An information processing method for simultaneous localization and mapping, comprising:
obtaining time-of-flight data of an environment of an information processing device;
detecting, based on the time-of-flight data, a floor in the environment;
obtaining image data representing an image of the environment;
tracking, based on the image data, the floor; and
localizing the information processing device in the environment, based on the detected and tracked floor.

16. The information processing method according to claim 15, further comprising: determining, based on the time-of-flight data, a height of the information processing device and a vertical direction in the environment relative to the detected floor.

17. The information processing method according to claim 16, further comprising: tracking the floor based on the height and vertical direction.

18. The information processing method according to claim 17, further comprising: determining, based on the tracking of the floor, a horizontal position and a horizontal orientation of the information processing device.

19. The information processing method according to claim 18, further comprising: localizing the information processing device based on the height, the vertical direction, the horizontal position and the horizontal orientation.

20. The information processing method according to claim 15, further comprising: obtaining sensor data, and detecting and tracking the floor further based on the sensor data and localizing the information processing device further based on the sensor data.
